(19) United States
(12) Patent Application Publication
(10) Pub. No.: US 2010/0045740 A1
(43) Pub. Date: Feb. 25, 2010

(54) FLUID DISPENSING SUBASSEMBLY WITH COMPLIANT APERTURE PLATE

(75) Inventors: John R. Andrews, Fairport, NY (US); Terrance L. Stephens, Molalla, OR (US); David A. Tence, Tualatin, OR (US)

Correspondence Address: MARGER JOHNSON & MCCOLLOM, P.C. - Xerox, 210 SW MORRISON STREET, SUITE 400, PORTLAND, OR, 97204, US

(73) Assignee: XEROX CORPORATION, Norwalk, CT (US)

(21) Appl. No.: 12/194,456

(22) Filed: Aug. 19, 2008

(51) Int. Cl. B41J 2/14

(52) U.S. Cl. 347/48

(57) ABSTRACT

A printer fluid dispensing subassembly has a fluid dispensing body having at least one transducer and at least one ink channel, and a compliant polymer aperture film having an array of apertures to direct fluid toward a substrate, the polymer aperture film bonded to the fluid dispensing body as an external layer of the fluid dispensing body, the polymer aperture film arranged to form a wall of a manifold in the fluid dispensing body and to attenuate acoustic energy. A printer fluid dispensing subassembly has a compliant polymer aperture film having an array of apertures to allow fluid to exit the fluid dispensing subassembly, and a fluid dispensing body bonded to a back surface of the polymer aperture film such that the polymer aperture film forms a wall of a fluid manifold, the film being arranged such that a side of the polymer opposite the fluid dispensing body is air. A printer has an ink supply, and a printhead to receive fluid from the ink supply and form images on a substrate by selectively actuating an array of transducers in a fluid dispensing subassembly, the fluid dispensing subassembly including a compliant polymer aperture film having apertures through which fluid is forced in response to the actuating of the transducers, the polymer aperture film arranged to attenuate acoustic energy from the actuating of the transducers.

### BACKGROUND

Some fluid dispensing assemblies use transducers or actuator to cause the system to dispense fluid. The actuators may be piezoelectric actuators, microelectromechanical (MEMS) actuators, thermomechanical actuators, thermal phase change actuators, etc. The actuators generally cause some sort of interface with the fluid to move to generate pressure in the fluid that in turn causes the fluid to move through an aperture to a receiving substrate.

In addition to causing the assembly to dispense or dispel fluid, the actuators may also create pressure oscillations that propagate into the fluid supply. These pressure oscillations give rise to droplet position errors, missing droplets, etc.

One example of such a fluid dispensing system is an ink jet printer. Generally, ink jet printers include some sort of transducer or actuator that cause the ink to move out of the print head through a jet, nozzle or other orifice to form a drop on a print surface. Pressure oscillations result in position errors, affecting the accuracy of the resulting print, missing ink droplets, affecting the color density of the print, and color density bands in prints.

### BRIEF DESCRIPTION OF THE DRAWINGS

FIG. 1 shows an example of a cross-section fluid dispensing subassembly having a steel compliant wall and air gaps.

FIG. 2 shows a cross-section of an embodiment of a fluid dispensing subassembly with a polymer film acting as a compliant wall and as a substrate for the apertures through which fluid is directed at a substrate.

FIG. 3 shows a top perspective plan view showing an embodiment of apertures in a polymer layer and an underlying manifold having several jetting devices connected to it.

FIG. 4 shows a flowchart of an embodiment of a method of manufacturing a fluid dispensing subassembly having a polymer aperture film.

### DETAILED DESCRIPTION OF THE EMBODIMENTS

Some fluid dispensing assemblies include a local ink supply and a fluid dispensing subassembly. The fluid dispensing subassembly may be viewed as having several components. First, the driver component may consist of the transducer, such as a piezoelectric transducer, that causes the fluid to exit the subassembly, the diaphragm upon which the transducer operates, and the body plate or plates that form the pressure chamber. Second, an inlet component consists of the manifold body that direct the fluid from the manifold toward the pressure chamber. Next, the outlet component directs the fluid from the pressure chamber to the aperture. Finally, the aperture itself dispenses fluid out of the printhead.

One example of a fluid dispensing subassembly is a jet stack in a printhead, the jet stack typically consisting of a set of plates bonded together. In this example, the driver would operate to cause the fluid to exit the jet stack through the aperture plate. The inlet would direct the fluid from the manifold towards the pressure chamber, and the outlet would direct the ink from the pressure chamber to the aperture plate. In the example of a jet stack, the aperture would dispense fluid out of the jet stack and ultimately out of the print head.

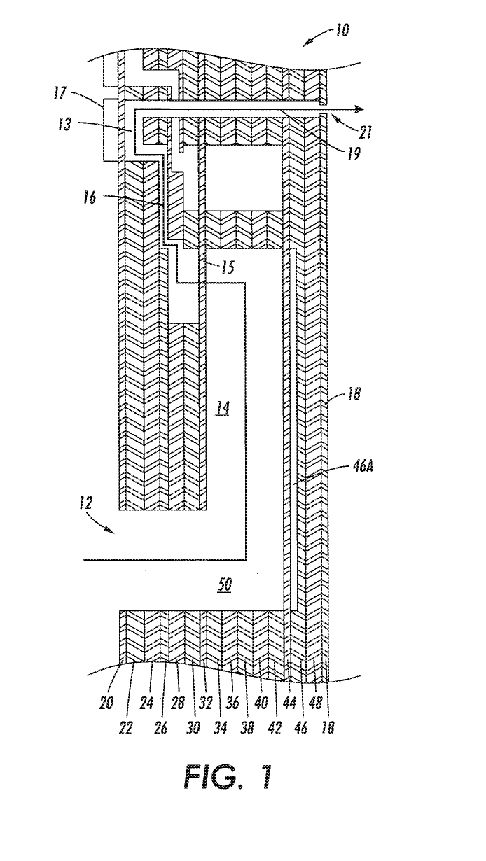

FIG. 1 shows an example of a jet stack in a printhead. The jet stack 10 consists of a set of plates bonded together in this example and will be used in the discussion. It should be noted that this is just an example and no limitation to application or implementations of the invention claimed here. As will be discussed further, the terms ‘printer’ and ‘printhead’ may consist of any system and structure within that system that dispenses fluid for any purpose. Similarly, while a jet stack will be discussed here to aid in understanding, any fluid dispensing subassembly may be relevant. The fluid dispensing subassembly or fluid dispensing body may be comprised of a set of plates, as discussed here, a molded body that has the appropriate channels, transducers, and apertures, a machined body, etc. As aspects of the embodiments include additional structures inside the jet stack than just the plates, the set of plates may be referred to as the fluid dispensing body within the fluid dispensing subassembly.

The jet stack receives ink from a reservoir (not shown) through a port 12. The ink may be in solid form, then melted and kept heated as it works it way through the solid ink printer. The ink flows through the manifold 14 having a compliant wall 44 and an air space 46A opposite the manifold, through a particle filter 15 and into to an inlet 16. The inlet directs liquid to a pressure chamber 13. When an actuator or transducer 17 activates, it causes the diaphragm plate 20 to deflect, and causes ink to flow through the outlet 19 and exit an aperture 21 on the aperture plate 18. The ink drops exiting the aperture form a portion of a printed image. The aperture plate 18 and the compliant wall 44 on the interior of the jet stack will typically be steel plates. The part of the ink path that includes the inlet, the pressure chamber, actuator, outlet, and aperture is referred to as the “single jet.”

The actuator, in addition to providing the pressure that forces ink out the apertures, also directs pressure oscillations back through the inlet and into the manifold. The pressure oscillations from several jets attached to the manifold can lead to larger amplitude pressure oscillations that then in turn influence the ejection of drops in the same and other drop ejectors. The manifold pressure oscillations lead to print defects such as banding and missing or misplaced drops.

The series or set of plates are etched, stamped or otherwise manufactured to form the various channels, chambers and features of the jet stack. In this example, the stack consists of a diaphragm plate 20; body plate 22; a separator plate 24; an inlet plate 26; separator plates 28 and 30; a particle filter plate 32; and manifold plates 34, 36, 38, 40, and 42; a compliant wall plate 44, a plate 46 providing an air space adjacent to the compliant wall, an aperture brace 44 and an aperture plate 18.

When the jet stack is made up from a series of bonded metal plates, a thin, stainless steel plate can form one wall of the manifolds internal to the jet stack. An air gap is generally provided next to the stainless steel plate opposite to the manifold to dissipate the pressure oscillations. The ability of the manifold wall to flex is called compliance and is thus referred to as a compliant wall. An example of this approach is demonstrated by US Patent Application Publication No. 2002/0196319.

However, because of it's high Young's modulus (˜200 GPa), the bonded stainless steel wall generally does not provide enough compliance, resulting in a need for larger compliant regions in the jet stack and more complex manifold shapes. This structure generally includes acoustic filters built into the jet stack using etched plates to form chambers inside the jet stack. An example of this approach is demonstrated in U.S. Pat. No. 6,260,963.

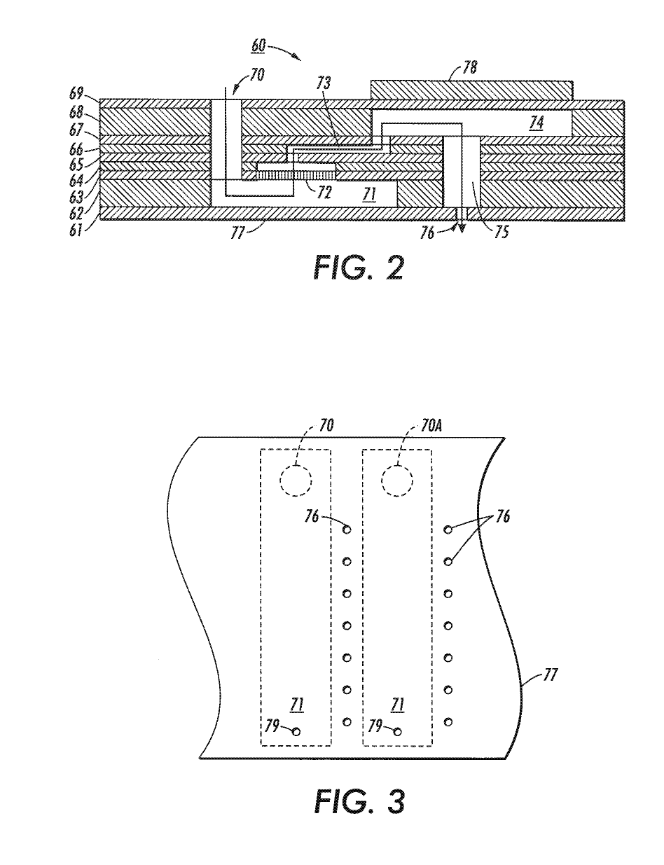

It is possible to increase the compliance and make the jet stack with fewer layers by using a polymer layer to provide the compliance on one wall of the manifold and to also provide the apertures through which the ink is directed toward the imaging member, referred to as a compliant polymer aperture film. An example of such a jet stack design is shown in FIG. 2. The printhead 60 has an ink port 70 that directs ink into a manifold 71 having a wall formed by the polymer layer 77. The ink flows through the particle filter 72 to the inlet 73 and into the pressure chamber 74. Transducer 78 operates to cause the diaphragm 69 to flex and push ink through the outlet 75 and out the aperture 76 in the polymer layer 77.

The plates of the printhead 60, not including the aperture film, may consist of the plates shown or other configurations of plates, depending upon the nature and application of the printhead. Therefore, the plates will be referred to as ‘a set of plates.’

FIG. 3 shows a plan view of a printhead similar to the printhead shown in FIG. 2. The polymer plate 77 is on the top surface with the apertures 76 shown adjacent to a manifold 71 located immediately below the polymer film. Openings in the polymer 77 over the manifolds permit the escape or expulsion of air that might be located or trapped in the manifold, the openings acting as purge vents. Multiple single jets are connected to a single manifold. The ink ports 70 and 70A provide the path for ink to flow into the printhead. Though a simple geometry is shown here with one column of apertures for each manifold, alternate configurations are also possible. For instance, ink from each manifold could be distributed to jets on each side of the manifold.

The polymer aperture film may consist of many different materials including polyimide, polycarbonate, polyester, polyetherketone, polyetherether ketone, polyetherimide, polyethersulfone, polysulfone, and liquid crystal polymer. The polymer aperture film may be adhered to the remainder of the jet stack with an adhesive such as acrylic, silicone, epoxy, bismaleimide, cyanoacrylate, thermoset polyimide or other thermoset or thermoplastic adhesives.

An added benefit of using a polymer film lies in the formation of the apertures. Using the polymer plate may allow other types of aperture formation such as laser drilling.

Another benefit in using the polymer sheet is the ability to conveniently add an anti-wetting coating to the side of the polymer plate that will face the print surface. For example, an anti-wetting coating could be applied as a bulk process on the rolls of the polymer plate material. This bulk film could then be cut and drilled in a single operation, drilling through both the polymer and the anti-wetting coating. This will keep the anti-wetting coating strictly on the face of the polymer aperture film and avoid it getting into the apertures and body where it could lead to performance characteristics.

It can be advantageous for the polymer layer to serve two different functions: as an aperture plate; and as a manifold compliant wall. This reduces the jet stack plate count and therefore the printhead costs. The dual use of the top plate is enabled by a jet stack design having the manifolds in the jet stack adjacent to the front polymer film.

In current implementations, compliance was added to long manifolds at the interior of the jet stack, running the length of the jet stack and over finger manifolds. The compliance was generally added with a thin stainless steel plate in the range of 25 microns thick forming one wall of the manifold and an air gap over the other side of the compliant wall. The air gaps etched in an interior plate are in a wall adjacent to the internal manifold in these implementations.

The Young's modulus of stainless steel is very high, in the range of 210 GigaPascals (GPa). This results in manifolds that are relatively wide to achieve even modest compliance. Having a wide manifold puts a limitation on design requirements because of the large area and provides limitations on jet density. Further, during the jet stack plate bonding and brazing process, the compliant wall may experience different dimensional changes than the rest of the jet stack. This can lead to bowing of the compliant wall and a consequent increase in its effective stiffness relative to a flat plate.

Introduction of a polymer film or layer as the compliant wall reduces or eliminates these issues. The Young's modulus of polyimide, as an example polymer, is very low, around 3 GPa. It is also conveniently available in 25 micron thicknesses allowing the use of same design rules as the stainless steel compliant wall. Within these same design rules, the polymer compliant wall yields roughly 100 times more compliance than steel, and is more effective in attenuating acoustic energy.

With the extra compliance capacity of the polymer aperture film, the lateral dimensions of the polymer compliant wall can be substantially reduced and still supply the same or more compliance than a stainless steel wall. This provides flexibility in the design rules, as the relatively wide manifolds may no longer be needed, allowing narrower manifolds and higher jet density.

The compliant wall may have a Young's modulus in the range of 50 GPa. In some instances, a compliant wall may have a Young's modulus in the range of 10 GPa. This allows the ink channels to be smaller than 1 millimeter (mm). As mentioned above, the polymer may be polyimide, polycarbonate, polyester, polyetherether keytone, polyetherimide, polyethersulfone, polysulfone, liquid crystal polymer and others. The polymer aperture film would be bonded to the jet stack using acrylic, silicone, epoxy, bismaleimide, thermoplastic polyimide and others. The polymer aperture film then forms an external layer of the jet stack and as one wall of the manifold.

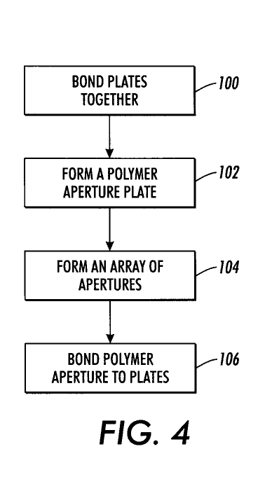

In addition to the higher compliance, the use of a polymer aperture film has other benefits, such as in the manufacturing process. Using a compliant polymer, the apertures may be formed by laser drilling or other high precision processes that alleviate problems inherent to the processing of steel components. An example of a manufacturing process is shown in FIG. 4.

Initially, the jet stack plates minus the aperture plate, and possibly the manifold plates that were previously internal to the jet stack, would be formed into a jet stack as 100. Generally the stack is formed by a brazing process. At 102, the polymer aperture film is formed. Generally, the aperture plate or layer is formed from a sheet of a polymer, typically by cutting the polymer into the appropriate sized sheets.

The array of apertures is then formed 104, such as by laser drilling, in the polymer. If an anti-wetting layer is desired, the anti-wetting layer could be applied to the side opposite the side to be drilled to form apertures. The anti-wetting coating could be applied to the polymer material prior to the formation of the polymer plate by cutting, such as when the polymer is in ‘roll’ form. The laser drilling would then occur through both the polymer and anti-wetting coating. The anti-wetting coating could be considered part of the forming of the aperture plate or in the forming of the array. Once the apertures are formed in the polymer plate, it is bonded to the set of plates at 106.

Alternative orders are of course possible. For example, the apertures could be formed in the polymer first and then the polymer film is bonded to the jet stack. The anti-wetting coating may be applied after the formation of the apertures. The formation of the polymer aperture film, including formation of the apertures and application of the anti-wetting coating, in whatever order those processes occur, may be done in parallel with the bonding of the jet stack plates and then the polymer film would be bonded to the jet stack.

In addition to the technical advantages of the manufacturing process, significant cost savings may be attained because of several aspects. First, the cost savings may result from the reduction of number of jet stack plates. Second, the cost savings may also result from laser drilling. Other cost savings may result from using a bulk anti-wetting coating of the polymer film. In addition, the cost of making apertures using the laser drilling scales approximately as the square root of the number of jets due to increased jet density.

It must be noted that the examples discussed herein are directed to ink and a jet stack referred to being a part of a printer. The term printer as used here applies to any type of drop-on-demand ejector system in which drops of fluid are forced through one aperture in response to actuation of some sort of transducer. This includes printers, such as thermal ink jet printers, printheads used in applications such as organic electronic circuits, bioassays, three-dimensional structure building systems, etc. The term ‘printhead’ is not intended to only apply to printers and no such limitation should be implied. Similarly, the above discussion has focused on ink as the dispensed fluid, but other types of fluids may also be dispensed.

For example, the above discussion may be viewed as a particular example of a fluid dispensing assembly having a fluid dispensing subassembly with a polymer, compliant aperture film. The fluid dispensing assembly has a local fluid supply provided to the fluid dispensing subassembly. The fluid dispensing subassembly in turn dispenses the fluid through a polymer aperture film, where the polymer aperture film also mitigates the effects of pressure oscillations in the fluid supply caused by operation of the transducers.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A printer fluid dispensing subassembly, comprising:
a fluid dispensing body having at least one transducer and at least one ink channel; and
a compliant polymer aperture film having an array of apertures to direct fluid toward a substrate, the polymer aperture film bonded to the fluid dispensing body as an external layer of the fluid dispensing body, the polymer aperture film arranged to form a wall of a manifold in the fluid dispensing body and to attenuate acoustic energy.

2. The fluid dispensing subassembly of claim 1, wherein the array of apertures are laser-drilled apertures.

3. The fluid dispensing subassembly of claim 1, wherein the polymer aperture film has a second set of apertures to provide for expelling air that is trapped in the manifold.

4. The fluid dispensing subassembly of claim 1, wherein the polymer aperture film further comprises one of the group consisting of: polyimide, polycarbonate, polyester, polyetheretherketone, polyetherimide, polyethersulfone, polysulfone, and liquid crystal polymer.

5. The fluid dispensing subassembly of claim 1, the fluid dispensing subassembly further comprising an adhesive to bond the polymer aperture film to the fluid dispensing body.

6. The fluid dispensing subassembly of claim 5 wherein the adhesive comprises a thermoset or thermoplastic adhesive.

7. The fluid dispensing subassembly of claim 6, wherein the adhesive further comprises acrylic, silicone, epoxy, bismaleimide, cyanoacrylate, and thermoplastic polyimide.

8. The fluid dispensing subassembly of claim 1, wherein the polymer aperture film has a Young's modulus of less than 50 GPa.

9. The fluid dispensing subassembly of claim 1, wherein the polymer aperture film has a Young's modulus of less than 10 GPa.

10. The fluid dispensing subassembly of claim 1, the polymer aperture film further comprising an anti-wetting coating on a front surface of the polymer aperture film opposite a back surface to which the fluid dispensing body is bonded.

11. A printer fluid dispensing subassembly, comprising:
a compliant polymer aperture film having an array of apertures to allow fluid to exit the fluid dispensing subassembly; and
a fluid dispensing body bonded to a back surface of the polymer aperture film such that the polymer aperture film forms a wall of a fluid manifold, the film being arranged such that a side of the polymer opposite the fluid dispensing body is air.

12. The fluid dispensing subassembly of claim 11, the film being arranged to attenuate acoustic energy.

13. The fluid dispensing subassembly of claim 11, the fluid dispensing subassembly further comprising an anti-wetting coating on a front surface of the polymer aperture film.

14. The fluid dispensing subassembly of claim 11, the polymer aperture film further comprising purge vents coupled to the manifolds.

15. The fluid dispensing subassembly of claim 11, wherein the polymer aperture film further comprises one of the group consisting of: polyimide, polycarbonate, polyester, polyetheretherketone, polyetherimide, polyethersulfone, polysulfone, and liquid crystal polymer.

16. The fluid dispensing subassembly of claim 11, wherein the polymer aperture film has a Young's modulus of less than 50 GPa.

17. The fluid dispensing subassembly of claim 11, wherein the polymer aperture film has a Young's modulus of less than 10 GPa.

18. A printer, comprising:
an ink supply; and
a printhead to receive fluid from the ink supply and form images on a substrate by selectively actuating an array of transducers in a fluid dispensing subassembly, the fluid dispensing subassembly including a compliant polymer aperture film having apertures through which fluid is forced in response to the actuating of the transducers, the polymer aperture film arranged to attenuate acoustic energy from the actuating of the transducers.

19. The printer of claim 18, the fluid dispensing subassembly arranged such that there is an exterior fluid manifold, and the polymer film is arranged to act as a wall of the exterior fluid manifold.

20. The printer of claim 18, further comprising a solid ink printer.

21. The printer of claim 18, wherein the transducers comprise piezoelectric transducers.
